(19) United States
(12) Patent Application Publication
(10) Pub. No.: US 2008/0175675 A1
(43) Pub. Date: Jul. 24, 2008

(54) Low-pressure, air-based, particulate materials transfer apparatus and method

(75) Inventor: Grant R. Wood, Smithfield, UT (US)

Correspondence Address: DAVID R. MCKINNEY, P.C., P.O. BOX 1460, SANDY, UT, 84091, US

(73) Assignee: ENSENTECH, Inc.;

(21) Appl. No.: 11/986,473

(22) Filed: Nov. 21, 2007

Related U.S. Application Data
(60) Provisional application No. 60/860,875, filed on Nov. 22, 2006.

(51) Int. Cl. B65G 53/08; B65G 53/34; B65G 53/48

(52) U.S. Cl. 406/61; 137/565.01

(57) ABSTRACT

This invention relates to a system, process, and the device for reducing energy usage by simplifying equipment and thus the power requirements for manufacturing, installation of the equipment required for use in the movement-transportation to/during the processing of granular particulate bulk, powder products, many liquids slurry-able materials. Many commonly identified materials will be in a granular, particulate and non agglomerative condition suitable for injection by auger or inertial gravity into an enclosed pipe or conveyance chamber. In the device, two distinct and specific air flow patterns are identified when mechanically-pneumatically established within a single, low pressure piping entity; 1. A unique self regenerating (for system length), pipe contained, Vortex air cushion, with zero linear variable velocity (ZVVAC). 2. A linear, low pressure, high velocity “core flow” of air (LPHVCF), or ZVVAC+, (the two features when combined), which carries the injected product or material thus eliminating energy consuming pipe contact within the conveying system in a frictionless, high speed environment without product degradations, where system processing-grading features are optimized specifically where system production costs, maintenance, and especially operational energy costs are reduced by 90 percent or more.

### PRIORITY CLAIM

The present application claims priority from U.S. provisional patent application Ser. No. 60/860,875, filed Nov. 22, 2006, and entitled LOW-PRESSURE, AIR-BASED, PARTICULATE MATERIALS TRANSFER APPARATUS AND METHOD.

### BACKGROUND OF THE INVENTION

The present invention is directed broadly to an improved and reduced energy requirement materials handling system for bulk engineering and foodstuffs in powder, granular, and liquid forms wherein these materials can be injected into a pneumatic air-operated device by whatever means is required. While materials are in the high air flow core, natural stratification and dehydration occur. These factors may be optimized at the cyclone or grading flow-system terminus-through the use of various classification, separation devices or features.

The present invention is directed more specifically to; 1. Reducing system manufacturing costs through simplification, 2. the reduction on operational energy costs, 3. the maintenance costs associated with materials handling through combining and simplifying the many outmoded and outdated costly steps in equipment production, and materials handling during transportation and/or processing.

In the operational context of the document the term, “Zero Velocity Vortex Air Cushion (ZVVAC),” refers to a pneumatic layer of very low pressure air in which has been generated a radial but (non-liner) vortex system by means of high velocity air flows and which “coats” the inside surface of a pipe, or enclosing system. The vortex generator(s) create(s) “Bluff Body” vortex on the inside surface of the pipe. Once the air flow turbulence pattern is established by the hereinafter described pump features, it is self generating for the system length to the terminus of the conveying device or pipe, and effectively eliminates contact friction between the transport medium (air), the carried product, and the conveyance device (pipe). Also, it must be remembered that the “materials” terminology can refer to simply conveying, or also to further processing while being moved longitudinally through the system within the Low Pressure High Velocity Core Flow (LPHVCF) (see illustration—FIG. 1) at a low pressure system velocity of 100 fps or more.

All bulk material handling systems in use by industry today are either static, (Hopper, conveyor belt, container, etc.) Or active (using some type of ‘fluid’ medium, air or liquid). All these systems use large amounts of energy, most of which is expended in overcoming friction in roller systems for conveyor belts, or friction in rollers and chains for hopper bucket systems, or overcoming viscous friction in mixing, and in pumps and piping where slurry systems are employed. In pneumatic and slurry systems, due to product density factors and viscous friction in piping, there is the need to move many times the amount of carrier material compared to the entrained product, all of which multiplies dramatically the manufacturing, maintenance, and especially the operational energy costs.

It is unnecessary to attempt to specify and quantify the myriad negative aspects of the currently employed materials handling methods and the costs for our national economy or the worldwide industrial society, when a system exists which is as efficient and profoundly cost effective as the one this document describes, one which has multiple applications in every industry and aspect of society. One example will suffice.

In a very large and complex mining operation with an underground crushing and classification system the waste material is presently backfilled into a mined out area. Transporting the waste material to the specified area requires either a fleet of continuously operating diesel L-H-D trucks or several thousand feet of 36 inches belted conveyor system with a crew of 18 men on constant assignment for maintenance and system reconstruction. To accomplish the same task with the (ZVVAC) plus the LPHVCF (hereafter referred to as the (ZVVAC+) system and thereafter maintain it would require only an initial construction crew of ten men to lay a thin wall PVC pipe of appropriate diameter (based on blower air requirements) the required distance, with a spreader system to distribute the waste at the terminus, and a ZVVAC+ pump to receive the waste material from the classifying components at the crusher. The total system cost would be less than 20% of the conveyor system and would require a small two men crew to “set” the discharge-spreader device once a shift, and maintain the electrical system to both ends of the ZVVAC+ pipeline. The electrical equipment required for this system would be 125 Hp for the roots type, positive displacement air pump, 75 Hp for the electrically driven auger (ZVVAC+ pump), and 20 Hp for the discharge-spreader. This is far less than 25% of the system electrical requirement of just the mechanical conveyor. By comparison, the mechanical system presently in use requires a total of eight 250 Hp motors, each driving a section of belt conveyor, and 100 Hp each for ingress and system egress components. Energy needs would be 200 Hp (or less) for the ZVVAC+versus 2000 Hp for the current system. All of the electrical cable in the mine, ventilation systems, control panels and especially safety factors would be tremendously altered as would the energy requirement which would dramatically change the generated power requirements from the “Grid”.

The Ecological and Governmental mandates to reduce pollution has necessitated programs to correct or compensate for industrial inefficiencies by reducing electrical power consumption. The key effort in all areas of industry should be to utilize such devices as the ZVVAC+ technology which dramatically reduces both; the size-complexity of all applicable components, and simplifies immensely the hardware and operational energy required for an applicable specific task.

As paradoxical as it may seem, the present levels of industrial efficiency have been attained through the magnificent ability of the industrial community to diversify and develop the many elements of material handling in existence today. Wide usage of the ZVVAC+ system would change some cost elements of every single product we consume in terms of equipment manufacturing, complexity, cost, goods, process, or production costs, but especially transportation energy cost.

All elements of material handling in widespread current usage have been in existence for more than 100 years. Even the basic understanding of pneumatic conveying with pressurized air were understood at the turn of the last century. Although the technicality of phase density, particle transit agglomeration, transport ratios per lb. of air, and a myriad of other technical data features have been delineated, there is little evidence in the literature that any major consideration has been given to the idea of using air as a friction reducing element in transporting goods, ores, etc., from one production or processing point to another in an enclosed piping system. It must be recognized however, that air has been tremendously useful in creating problems which then necessitated the utilization of scrubbers, bag houses, and many other technologies to remove particulate emissions and clean the atmosphere. All at a very high cost in hardware and in all forms of operational energy.

There have been many examples in the prior art which utilize air for the processing of grains and foodstuffs. For example; possibly one of the earliest air processing machines was the McCormick threshing machine, and of course the resultant flour milling equipment of J.I. case and others, but all of these relied on the simplest of paddle wheel fans to produce air movement. Military requirements for deballasting submarines with high pressure, positive displacement pumps resulted in the development of the currently efficient lobed rotor positive displacement roots type pump. These pumps are a required element of the ZVVAC+ technology, where velocity-pressure impulses are the key factors necessary to develop and maintain the vortex cushion layer air flows. LPHVCF system gauge pressures of less than 5 psi. are the observable factors.

### SUMMARY OF THE INVENTION

In accordance with the present invention, an apparatus and process is presented for material handing and processing which is provided wherein any and all applicable industrial materials and foodstuffs which are of a quality and consistency which are injectable by gravity, mechanical, hydraulic, or pneumatic means into a high velocity core airflow in piping, or other enclosed linear container, wherein the device component arrangements have created and introduced a zero linear velocity to the vorticular layer air flow onto the innermost surface of the containment device, thereby eliminating product friction therefrom, and thus minimizing the electrical (or mechanical) energy requirements for processing and moving the material from point A to point B.

An object of this invention may be also to provide the means to alter product quality to a predetermined standard thru processing of the conveyed materials in-situ, or preparing materials for exit processing as they leave the piping system to enter devices such as classification bins, product separation cyclones, wherein separated elements of the product such as chaff and foreign matter are removed from the grain, and where mined or milled materials may be separated by specific gravity or size fractions allowing collection in sequential component bins, and also where hygroscopic, surface, and entrained moisture separated from the product are released into the atmosphere or collected into re condensation devices, processing systems, bag houses etc.

Further objects of this invention are; to allow the rapid and efficient transportation of laboratory, or medical grade, or toxic and/or abrasive materials in enclosed systems, wherein atmospheric or biologically hazardous contamination can be prevented or eliminated. Equipment requirements and operational energy costs are absolutely minimized to enhance; processing capability, corporate earnings, and maximize public safety.

An additional object of the invention is to provide ZVVAC+ pumps with the different configurations required for specific applications in industry. The Linear Accelerator Pump (LAP) is the configuration shown in FIGS. 1-6, and will be described as LAP-1. The basic pneumatic operating principles are the same for all configurations even though component arrangements are markedly different. The Positive Reverse Dredging type 1 (PRD-1) pump is shown in FIG. 7, and the Down Hole Vertical unit (DHV, and depicted in FIG. 8 will be referred to as the DHV-1.

Three Common Pump Elements. All above described systems are all composed of three main primary elements plus the product transfer pipe line (or hose) and any required terminus equipment, each with a specific purpose. First, is a positive displacement lobed rotor (Roots type) air pump. Second, an auger, or some type of positive inertial material injection device which will often be combined with a backflow preventing vane, flapper, and shutter type metering device. And Third, the Pump head with its internal zero line velocity vortex air generation and product injection (pumping) features.

Element No. One. The variable speed, engine driven, positive displacement air pump (lobed rotor ‘Roots Blower’) is to provide a sufficient quantity of air to allow the injected material, encased within the high velocity ‘core’ air flow, to reach system terminal speed based on airflow velocity-pressure factors and pump design, all of which are predetermined to deal with the specific material being carried. For example, for a 10-inch pump carrying corn the speed is likely to be 160 feet per second, but can be much greater or considerably less depending on design and transport tonnage criteria. In test presentations pressure gauge readings under system load condition were never above 2 psi at the blower or pump outlet—line pressure gauge. The auger has two, and in some configurations three basic functions. The first one is to meter the product as it enters the hopper area and to evenly distribute this material along the flights of the auger prior to function No. 2, which is to inject the pumped material into the LPHVCF at the pipe inlet where the air cushion layer (ZVVAC) is being established on the inside surface of the product line by the “bluff body” air system, near the auger, spider bearing and vortex chopper assembly.

Element No. Two, the pump ‘head’ consists of a series of baffles, either moving and/or fixed (and in some instances pipe or hose) which directs the low pressure air from the positive displacement pump into a smoothly tapered air conduit. This conduit, in continuation, becomes the product carrier pipeline. Inserted into the tapered air conduit is a cylindrical housing carrying the product insertion inertial auger (or some other type of inertia generating system such as a ‘product metered’ gravity chute). At the end of the product delivery auger housing is a blowback control, which is opened as the product enters the auger (or chute) system and forms a product seal. The seal prevents major air pressure reversion (blowback) into the hopper-bin area.

Element No. Three. Situated at the critical points in the tapered pipe-pump head is a machined ‘baffle plate bluff body’ or other ‘bluff body vortex generator’ in concert with the tapered entity, machined baffle plate and the auger with the tapered entity, machined baffle plate and the auger end configuration any or all assist in producing the zero velocity vortex air cushion flow (ZVVAC). After once being established within the ZVVAC+ pump head as a layer of radial vortex on the inside surface of the pipe. The ZVVAC+ is continuously self generating throughout the piping system. All of the dimensions within the ‘pump head’ are critical to the establishment of the ZVVAC. When any single feature is out of focus the continuous zero velocity vortex air cushion layer will not occur and we would simply have a viscous flow pneumatic system, with all of its negative elements and expensive operational power requirements.

The piping system is (because of the low air pressures) constructed of the cheapest and most easily installed materials. It usually consists of thin wall PVC pipe but can be of virtually any material suited for ease of handling and/or installation. Since there is no wear causing friction or high hydraulic or pneumatic pressures to deal with, virtually any standard engineered plastic or metal piping system will be satisfactory. Often existing pneumatic system piping can be utilized.

The system terminus will usually be some type of cyclone, (product velocity reduction system) but will often have a product separation chamber(s) where moisture, or foreign matter, is removed from the product, or where particle size have stratified to be separated according to specific gravity, usage and purpose. For the handling of bulk wheat, and grains, open discharge into hoppers, silo, etc. from the product lines could occur but system usage would be optimized if a cyclone were employed to allow excess moisture to escape and chaff, and other foreign material, to be collected and removed.

### DESCRIPTION OF THE PREFERRED EMBODIMENTS

In the preferred embodiment(s) of this system, incorporation of the previously described features are utilized as they are selected from the following engineered specifications and ZVVAC+ pump features requirement list:
NOTE: Since ZVVAC+ pump-systems are “product specific” the following list-items must be considered for each application, and sometimes location.
1. Product line size (pipe Diameter and Pump size) as related to TPH (tons per hour) capacity and type of product being handled.
2. Configuration and taper of airflow control nose cone.
3. Spacing between auger barrel-vortex generator(s) and nose cone air chamber wall.
4. Product velocity—air requirement-volume & velocity in the piping system.
5. Product insertion velocity—determined by setting the variable speed auger RPM or product metering parameters.
6. Auger pitch, vortex placement and other auger features to generate a zero linear vortex velocity air cushion on inside of product line and optimally insert conveyed product into high velocity “linear core” air flow.
7. Back flow sealing qualities of product in auger.
8. Back flow gate placement.
9. Vortex generating features of bluff body ring on end of auger barrel or inside of nosecone (when used).
10. Retractable shut-off back-flow gate configuration.
11. Nose cone chamber length and C.F.M. air flow requirement.
12. Feed chamber and auger inlet window.
13. Auger terminus configuration for optimum ZVVAC and/or vortex segmentation from the auger housing bluff body, and auger vortex chopper.
14. Air box feed configurations
15. Auger RPM and SFPM in flighting, (variable).
16. Drop distance and product feed angle into auger.
17. Surface condition and/or coating of flighting.
18. Metering-feed controls—product feed rate into auger.
19. Accumulator effect—distance and size of air line from blower to pump head and/or volume of air box w/internal blower position.

Through utilization of information from the above specified variables, a truly unique device can be constructed which provides a process and system unlike anything now in current usage in terms of system construction economics, materials transportation energy costs, operating costs, and operating efficiency in moving and/or processing the majority of applicable bulk products.

The invention itself, together with further objects and attendant advantages will be understood by reference to the following detailed descriptions taken in conjunction with the accompanying drawings.

### DESCRIPTION OF THE DRAWINGS

FIG. 1 is a block diagram of components and sequence of parts and nomenclature for a complete operational ZVVAC+ (ZVVAC-LPHVCF) system.

FIG. 2 is an exploded view of the pump & components, and into the end of the nose cone, showing the vortex chopper, and auger support spider with location of the reversion slide valve or optional flap valve.

FIG. 3 is a vertical view of the auger flights looking downward through the hopper opening.

FIG. 4 is an end view looking at the output end of the auger housing

FIG. 5 is a cutaway view showing possible pump head locations for “Bluff Body” Vortex Generating features: (a) Inside nose cone, (b) Auger housing end, and (c) nose cone terminus of the air deflecting ring (bluff body vortex generating ring). The bluff body vortex generating rings is a major factor in creating the turbulence zone described herein as the ‘zero linear Velocity Vortex Air Cushion, (ZVVAC) as attached to the outside surface of the auger barrel, or the inside of the nose cone.

FIG. 6 is a horizontal cutaway of a “pump” in the LAP-1 configuration.

FIG. 7 is a skeleton cutaway diagram of a “pump” in the PRD-1 configuration.

FIG. 8 is a vertical cutaway of the “pump” in the DHV-1 configuration.

FIG. 9 is a skeleton cutaway diagram of the LAP-1 “pump” showing the bluff body vortex generator locations and the vortex segmentor at the auger termini.

### DETAILED DESCRIPTION OF THE INVENTION

### With Reference to the Drawings

### Like Numerals are Used to Designate Like Parts Throughout the Drawings

Turning now to the drawings,

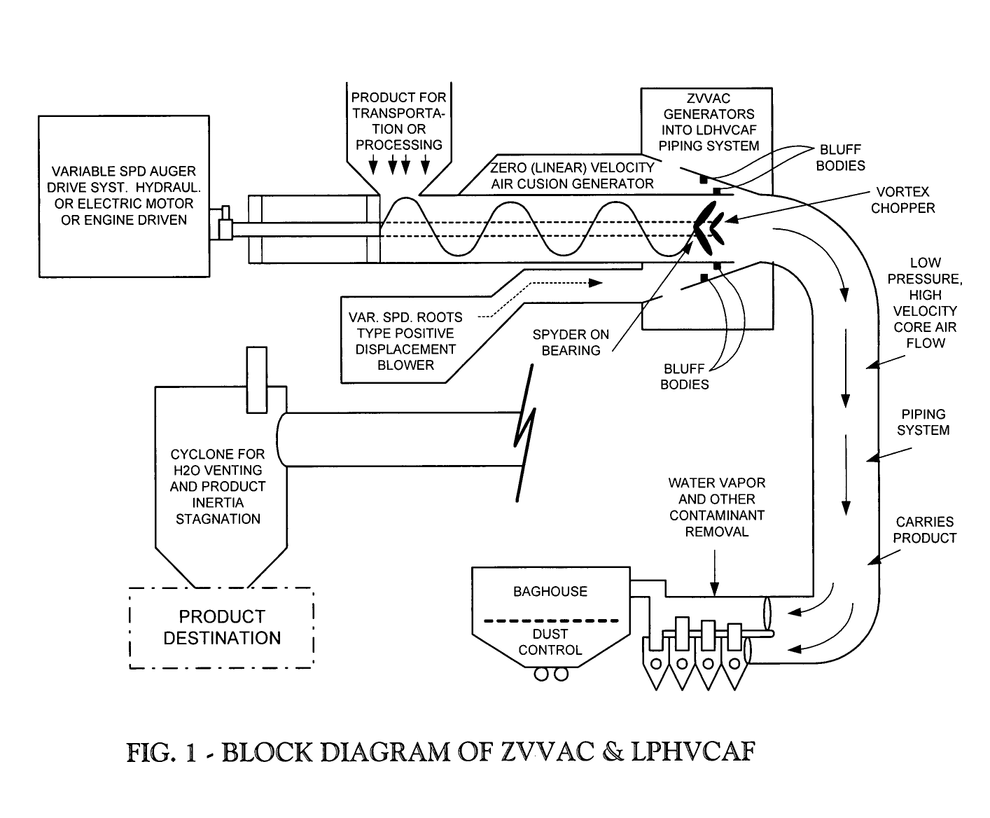

FIG. 1 shows a block diagram and the system layout and component arrangement sequence for the ZVVAC+ system with each component labeled for functional identification.

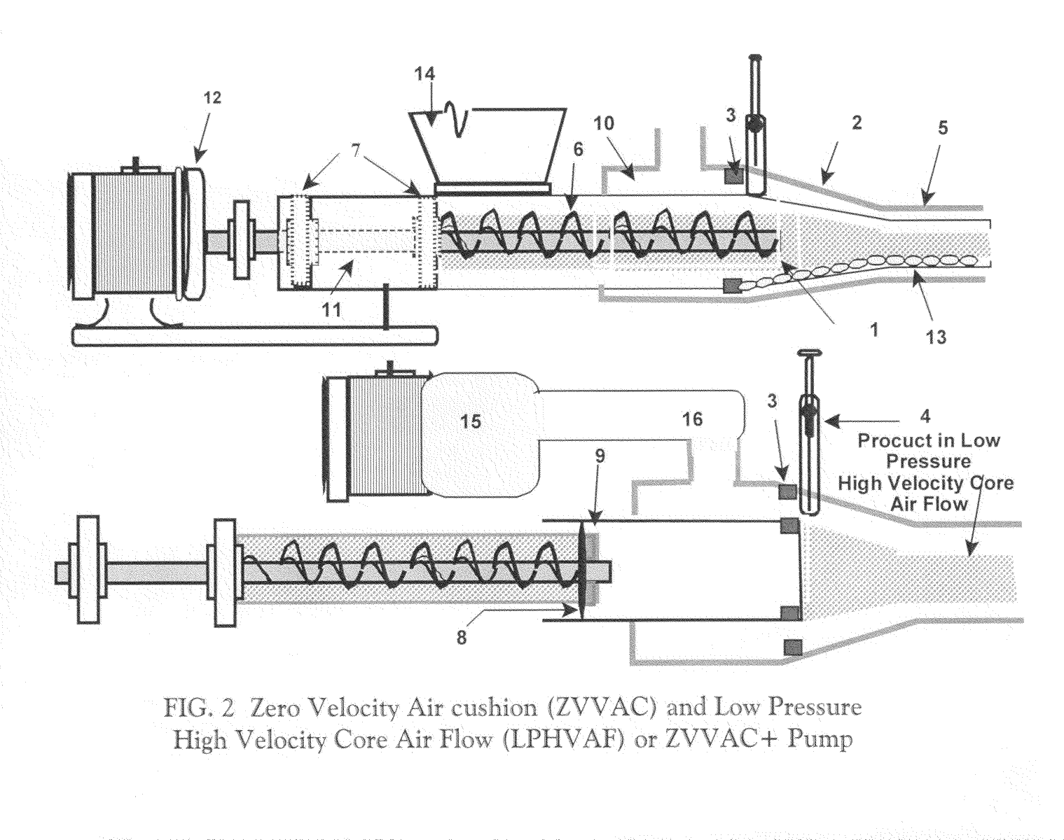

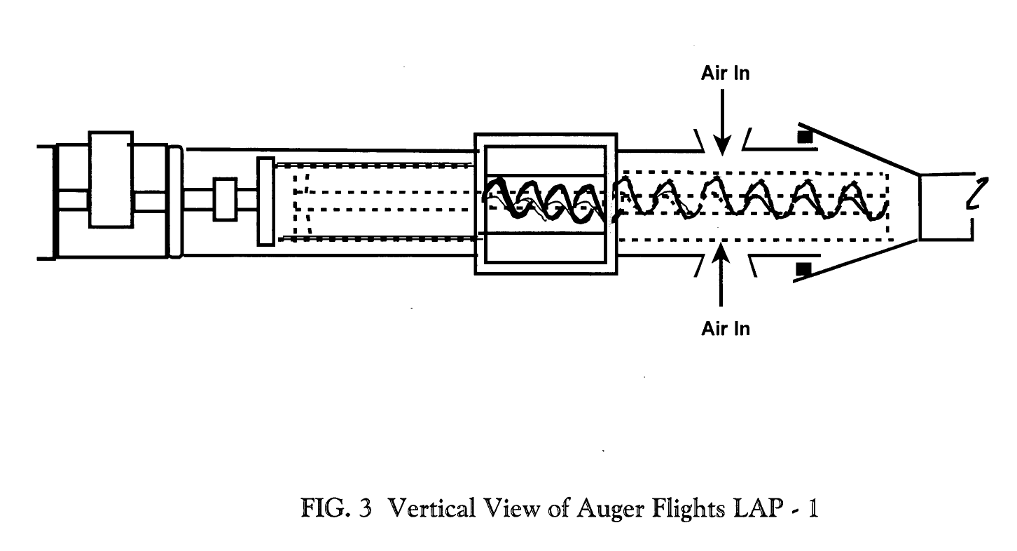

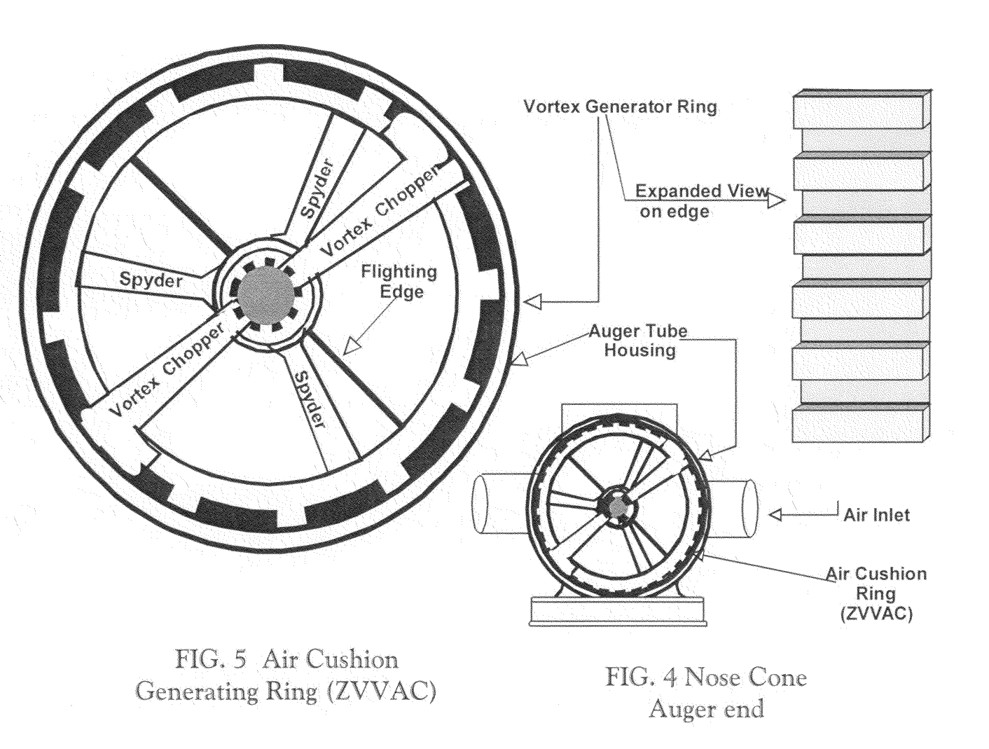

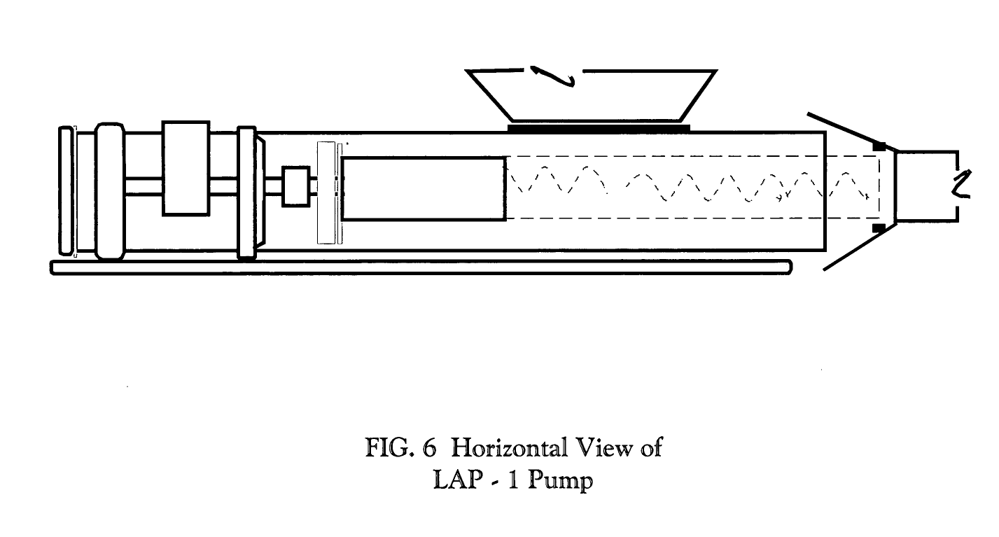

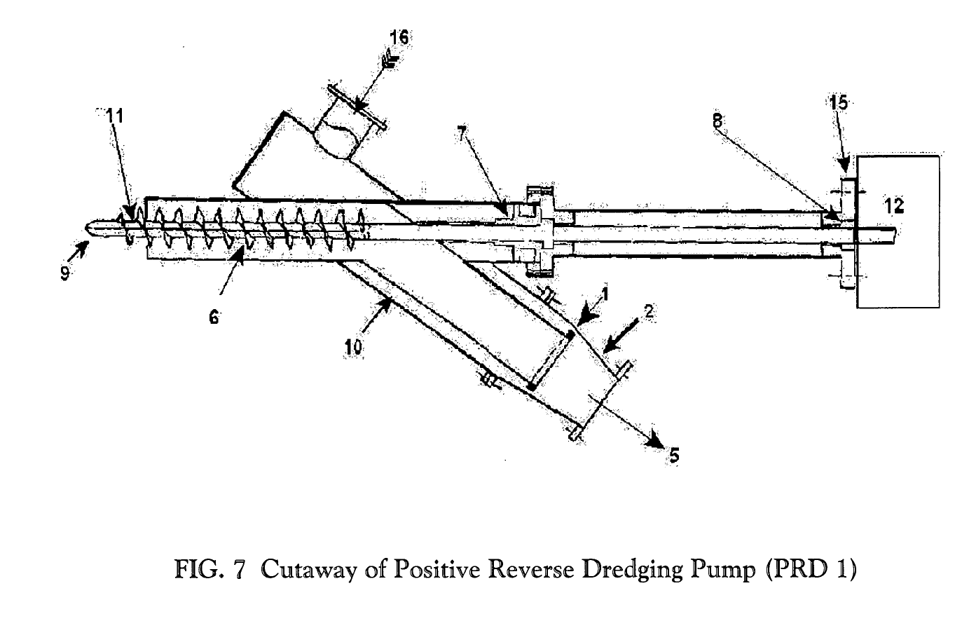

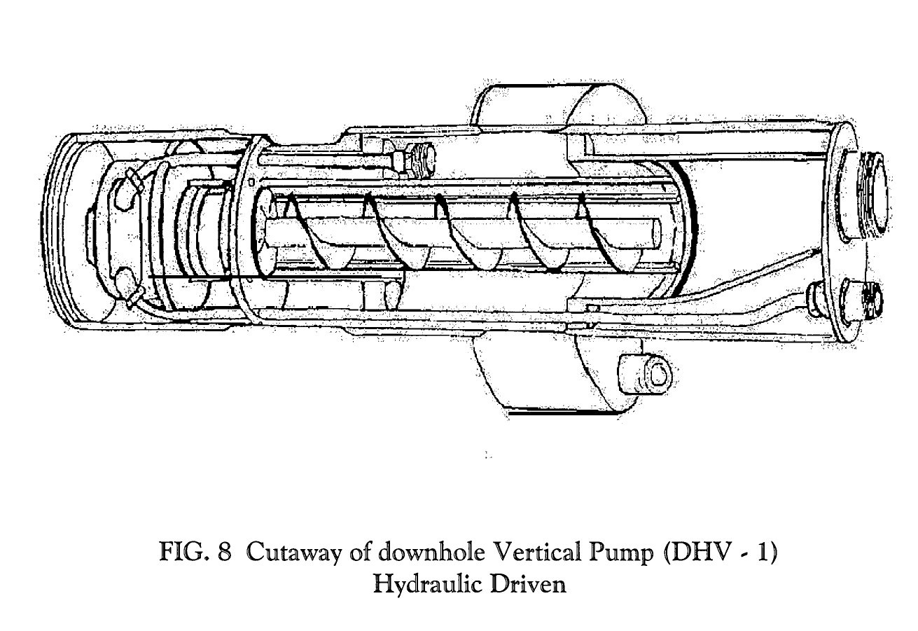

FIG. 2 shows the preferred embodiment of the ZVVAC+ in the Linear Acceleration Pump (LAP-1) configuration with the various key parts and vital design elements defined (numbered) as follows.
No. 1 is the clearance between the cantilevered auger end and the tapered nose cone.
No. 2 tapered nose cone.
No. 3 is the bluff body air cushion vortex generating ring which may either be attached to the cantilevered auger housing end, No. 3, or positioned concentrically within the tapered cone.
No. 4 is the air reversion valve, or flap valve.
No. 5 is the product receiving line and becomes the product carrier-piping system with the ZVVAC+ throughout the system.
No. 6 is the product acceleration-insertion auger which is composed of the drive-end cantilever section of shafting supported by two bearings as shown
No. 7 Bearings with seal and auger flighting attached.
No. 8 Spider (auger stabilizer) bearing.
No. 9 is the flighting end piece.
No. 10 is the air guide box-manifold which receives the high volume low pressure air from the “Roots” type blower, No. 15.
No. 11 Cantilevered Auger Shaft with flighting.
No. 12 Variable Speed Drive System
No. 13 Zero Velocity Air Cushion (ZVVAC)
No. 14 Product Feed Hopper
No. 15 Variable Speed “Roots” Blower.
No. 16 Air insertion path to No. 10.
   NOTE: The ‘air box’ may in some system configurations also be utilized to enclose the blower and its drive system, when the blower is variable speed, and electrically, hydraulically or diesel engine driven.

### DETAILED OPERATIONAL, and THEORETICAL DESCRIPTION OF THE INVENTION

The unique feature of this invention is; the ability to generate a Zero (linear) Velocity Vortex Air Cushion (ZVVAC), and to maintain it for the length of the piping system based upon the physical airflow and velocity characteristics of the Low Pressure High Velocity Core (air) Flow (LPHVCF). It must also be pointed out that additional beneficial and useful conditions occur in the LPHVCF as transported materials are stratified-separated according to specific gravity and/or particle size. For example, chaff and dust are removed from grain, heavy precious metals are concentrated from gangue or silica sand, etc., and small rocks-extraneous material and moisture are removed from sawdust or wood chips. And, the moisture content of gravel aggregate may be reduced or controlled. Cyclones or Separating/grading bins at the pipeline terminus can optimize and stabilize any and/or all of these features. The reader will remember seeing the tiny whirlpool in the bathtub drain. This condition occurs when atmospheric pressure attempts to fill the void in the drain pipe as a disruptive flow occurs at right angles to the static pressure flow zone. This flow pattern is commonly termed vorticular flow. In circumstances of fluid flows where what is termed a “bluff body” (Chap. 1, Pp 94-97), restriction exists in a fluid flow, and where the trailing edges of the bluff body are sharply defined at approximately 90 degrees to the Mean fluid flow path, a low pressure zone behind the sharp edge (corner) is created. Dynamic pressure attempts to ‘fill up’ the low pressure void. The size and characteristics of the vorticular “whorls” or coils of rotating fluid thus generated are entirely dependent upon the configuration of the bluff body(s) and the pressure-velocity-pulsation characteristics of the ‘dynamic’ primary fluid flow.

The internal mechanical arrangement of pump elements of the device is such that a bluff body vortex generator is placed in the ‘nose cone’ airflow pattern where vortex action is enhanced-promoted by pulsations from the auger rotation. In fact, the end of the auger tube acts as a bluff body, and is in the appropriate airflow position to generate sufficient vortex action, (with pulsations from the auger rotation) to start the ZVVAC. This condition is only generated when the appropriate air flow rates occur and target velocities are achieved, as dictated by internal nose cone configuration, clearances and auger rotational (pulsation) speed. When the pipeline interior surface is covered with vortex conditions thus generated, a ZVVAC has been achieved.
NOTE: Proper system operation does not occur when an, identical pressure velocity static compressed air source, is employed. This indicates that the slight pressure-volume “ripple” from a directly connected roots type lobed rotor air pump is responsible for the pressure variations which allow the vortex rings to form behind the “bluff body” features in the nose cone of the apparatus.

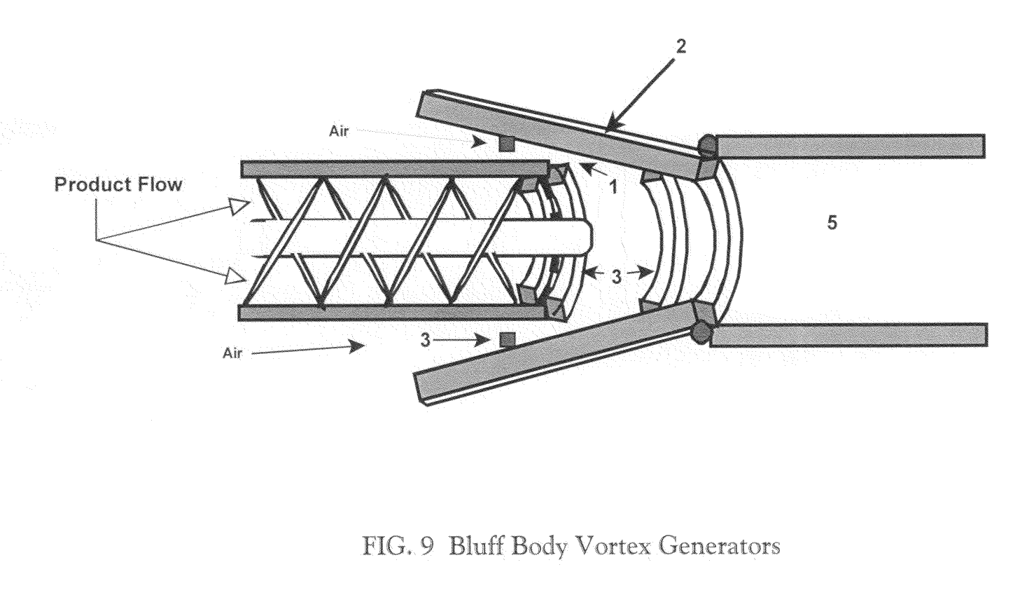

One extremely important item must be explained here. According to “Baker”, (1. Pp 94-97) “the vortex shedding body must have well-defined edges . . . the spin imparted to a fluid by shear, is shed from the sharp edge of the bluff body.” With the arrangement of internal parts of the ZVVAC the primary vortexes are generated from the outside trailing edge of the auger housing, or either or both of the other two possible locations (see FIG. 9). The free floating vortex rings or impulses, then migrate (through the linear air flow) across the small clearance opening, to the tapering inside wall of the nose cone. Varying air pressures, product turbulence, linear velocity flow, all normally would be expected to be disruptive of the necessary vortex pattern and to destroy it, but in fact when all flow rates and specified conditions are correct, all the factors combine to actually achieve the opposite. The generated vortexes are ‘stacked’ or layered on the inside wall of the pipe to form the ZVVAC+. In the explanation of this phenomenon the reader is asked to consider each vortex as if it were a roll of toilet paper with a ‘free’ end. When rolled one way the free end will trail away and with each rotation roll size is diminished by the paper thickness until it is destroyed, but, if the direction of the roll is reversed, this loss does not occur and the roll maintains it's integrity, and in fact by some means, not yet theoretically understood, standardizes this pneumatic feature throughout the piping structure or system.

This situation is in fact what happens with the ZVVAC+. As the vortex shedding occurs from the device elements the vortex units are transferred linearly to the interior of the nose cone-piping system as they establish the Zero (linear) Velocity Vortex Air Cushion. The ZVVAC vortexes are then regenerate by the action of the LPHVCF as it moves from the ‘Pump’ head to the piping system terminus. It is theorized that the auger terminus configuration is of extreme importance in segmenting/establishing the vortex flow in such a manner that the air flow-vortex pattern is established (‘projected’) through the curtain of flowing air moving along the tapered pump ‘nose cone’ interior surface. It is of significance that “Baker” (1) suggests the cone surface angle should be between “30 and 30/2 (15) degrees,” and provides the ‘Strouhal Number’ wherein we can calculate the rate of vorticity shedding from a bluff body in a given mean airflow velocity. The formula is S×fd/v, and the rate of vorticity shed from a sharp edge of a suspended-free standing bluff Body is=V squared/2. (Baker, 1. pp 95) defines vorticity and states; “vorticity, the spin imparted to a fluid (air) by shear, is shed from the sharp edge of the bluff body into the large rolling up vortex until it is ‘full’ and is then shed downstream”.

Since “shed”, or free floating vortex, would likely have little value as an air cushion and the existence of the zero linear velocity air cushion is demonstrably obvious within very stringent velocity and mechanical parameters of this system, it is theorized that; “Any specifically identified (by position) radial vortex layer, or sequence, acts as a ‘bluff body’ causing the next radial vortex layer to generate itself, and so cascade on and on throughout the piping system at right angles (90 degrees to the core air flow) to the product piping terminus.

Thus; The statement is that the unique arrangement of internal parts in this invention generates a radial vorticular flow within the “Pump” head at very specific linear ‘core’ air flow velocities. The air flow pattern around the inside of the tapered nose cone, and/or one or all of the three bluff bodies situate in the ‘head’ of the device, (see FIG. 9) starts the radial vorticular flow which cascades along the inside of the piping system at right angles (90 degrees) to the core air flow.

It is also imperative that the reader understand that this whole system is dependent on—air flow velocities with PRESSURES only sufficient to maintain those velocities in an essentially ‘open’ ended piping system (0 to 2 psig).

The landmark article by Maulbetsch (2. Pp 34-37), states the observed fact that, “small, light particles suppress turbulence while large, heavy ones enhance it”. This statement is explanatory of the condition where an established ZVVAC+ flow remains continuous for the length of the piping system when it is loaded with product and is also a partial explanation of the fact that the system can be loaded with product, then shut down and restarted without apparent blockage or product degradation.
NOTE: Previous explanation, and the following claims have been discerned from actual working units and the specific operational parameter will only be discussed in the future through the medium of Computational Fluid Dynamics as it is applied to each minute element but most importantly to the vortex generating mechanisms found in the bluff bodies of the pump head, and then measured in the core air flow and cushion air flow at many points within the piping system, and at the terminus.

I claim:

1. A powder and bulk materials processing and transporting device which monumentally reduces energy costs for the production of the materials of construction, and thereafter for maintenance, and transporting and handling selected products comprising:
a body having an inlet for pressurized air from a variable speed, lobed rotor, “Roots” type blower and an outlet;
a opening into an air box situate around an auger housing
with an outlet somewhat parallel thereto but containing “bluff body” vortex generators situated at, or near, the outlet thereof;
a opening into a auger housing containing a variable speed, cantilevered auger, rotated there-within by an unspecified energy source, but possessing a pneumatically driven vortex generator enhancement feature on the exterior ending thereof as a ‘bluff body’, and a rotating vortex chopper on the end thereof
a auger cantilevered with an output end vibration eliminating bearing-spyder affixed to the inside of the auger housing.
a auger rotated by an unspecified energy source to impart initial linear motion to all product so that product is injected thru a spider (if needed) into a low pressure high velocity core ‘air’ flow (LPHVCF) in a pipeline where the ZVVAC is present.
a flap or other type of slide valve to prevent air reversion from the roots blower into the cantilevered auger barrel-housing and thence into the product entry passageway during startup;
a flap or other type of slide valve to prevent air reversion from the air source, said valve which is operated by interconnecting devices to operate said valve and product release valve in proper sequence thereto;
a ‘bluff body’ vortex generator positioned with one surface parallel to linear air flow and one sharply defined edge situate at 90 degrees thereto with a vortex pocket thereafter, and said generator located in one or more of three locations sufficient to cause the creation (generation) of vortex to cover the pipeline interior surface for ‘zero linear velocity vortex air cushioned’ flow;
an opening into a tapered pipe, (nose cone) and a pipe wherein ‘bluff bodies’ have generated a stable, established vortex air cushion;
a pipe which is product-specific and of appropriate size to allow; firstly, a zero linear velocity air cushion on the inside surface thereof, and secondly, a linear velocity core air flow in the center thereof, to allow the frictionless movement of product throughout the piping length and to the terminus features or devices;
a materials flow pattern which promotes the stratification of product at sufficient velocity to allow exit processing to remove moisture, dust, foreign material and thus enhance product quality.
